(19) United States
(12) Patent Application Publication
(10) Pub. No.: US 2008/0103009 A1
(43) Pub. Date: May 1, 2008

(54) Self-contained torque-coupling assembly

(76) Inventor: Jungho Park, Ann Arbor, MI (US)

Correspondence Address: BERENATO, WHITE & STAVISH, 6550 ROCK SPRING DRIVE, SUITE 240, BETHESDA, MD, 20817, US

(21) Appl. No.: 11/589,882

(22) Filed: Oct. 31, 2006

(51) Int. Cl. F16H 48/06; F16D 43/28

(52) U.S. Cl. 475/231; 192/103 F

(57) ABSTRACT

A torque-coupling assembly comprises a shaft member, a fluidly sealed hollow coupling case containing an amount of a hydraulic fluid therewithin and rotatably mounted about the shaft member a friction clutch assembly disposed within the coupling case for selectively engaging and disengaging the coupling case and the shaft member, and a hydraulic pump disposed within the coupling case for generating a hydraulic fluid pressure to frictionally engage the clutch assembly and supplied with the hydraulic fluid contained in the sealed coupling case. Thus, the torque-coupling assembly of the present invention is self-contained so that it does not require a supply of hydraulic fluid stored outside the frictional clutch assembly.

### BACKGROUND OF THE INVENTION

1. Field of the Invention

The present invention relates to torque-coupling assemblies in general, and more particularly to a self-contained, fluidly actuated torque-coupling assembly.

2. Description of the Prior Art

Typically all-wheel drive (AWD) vehicles are built by adding a PTU (power take off unit) and an auxiliary rear axle to a FF (front-engine, front-wheel-drive) car. Full-time AWD vehicles employ a PTU that contains a center differential. Part-time or on-demand AWD cars employ a simpler PTU without a center differential and a torque-coupling assembly positioned between the PTU and the rear axle. Usually, the torque-coupling assembly is a clutch device that is activated at will via an electromechanical actuator or an electro-hydraulic actuator. The prior art torque-coupling assemblies are constructed by attaching the clutch device at the pinion-gear shaft of a rear differential unit and by containing it inside its own coupling housing that is in turn mounted in front of the differential housing. Typically, the clutch device comprises a coupling case, a side cover, a multi-plate clutch pack, and an actuator. A separate U-joint yoke is attached at the end of the clutch device. Such an arrangement requires a bearing to radially and axially support the clutch device on the coupling housing.

The clutch device is normally actuated by various hydraulic actuator assemblies, which are constructed of elements disposed inside a coupling case. The hydraulic actuator assemblies often include displacement pumps disposed inside the coupling case and actuated in response to a relative rotation between the coupling case and the output shaft. The displacement pumps are usually in the form of internal gear pumps, such as gerotor pumps adapted to convert rotational work to hydraulic work. In the internal gear pumps, an inner gear having outwardly directed teeth cooperates with an external gear having inwardly directed teeth so that fluid chambers therebetween increase and decrease in volume as the inner and outer gears rotate in the coupling case. The current hydraulic torque-coupling devices are not self-contained in a sense that they require a supply of hydraulic fluid stored outside the frictional clutch device. In other words, they are require a non-rotatable housing external to the coupling case, which is typically attached to an axle housing or a transfer case. This complex structure of the torque-coupling assembly not only makes the system bulkier but also makes it hard to assemble and expensive to manufacture.

Thus, while known hydraulic couplings, including but not limited to those discussed above, have proven to be acceptable for some vehicular driveline applications and conditions, such devices are nevertheless susceptible to improvements that may enhance their performance and/or cost. With this in mind, a need exists to develop improved torque-coupling assemblies that advance the art and to simplify the overall structure of the torque-coupling assembly.

### SUMMARY OF THE INVENTION

The present invention provides an improved fluidly actuated torque-coupling assembly. The torque-coupling assembly in accordance with the present invention comprises a shaft member, a fluidly sealed hollow coupling case containing an amount of a fluid therewithin and rotatably mounted about the shaft member a friction clutch assembly disposed within the coupling case for selectively engaging and disengaging the coupling case and the shaft member, and a fluid pump disposed within the coupling case for generating a fluid pressure to frictionally engage the clutch assembly and supplied with the fluid contained in the sealed coupling case. Thus, the torque-coupling assembly of the present invention is self-contained so that it does not require a supply of fluid stored outside the frictional clutch assembly.

### BRIEF DESCRIPTION OF THE DRAWINGS

Other objects and advantages of the invention will become apparent from a study of the following specification when viewed in light of the accompanying drawings, wherein:

FIG. 1 is a schematic diagram showing a drivetrain of an all-wheel drive motor vehicle in accordance with the preferred embodiment of the present invention;

FIG. 2 is a sectional view of a torque-coupling assembly according to the preferred embodiment of the present invention mounted to a drive axle of the motor vehicle;

FIG. 3 is an enlarged sectional view of the torque-coupling assembly according to the preferred embodiment of the present invention;

FIG. 4 is an enlarged sectional view of the torque-coupling assembly according to the alternative embodiment of the present invention;

FIG. 5 is an enlarged sectional view of a variable pressure relief valve assembly according to the preferred embodiment of the present invention showing a pressure-control spool valve in an open position;

FIG. 6 is an enlarged cross-sectional view of an end plate of the torque-coupling assembly;

FIG. 7 is an enlarged side view of a spool member of the pressure-control spool valve.

### DETAILED DESCRIPTION OF PREFERRED EMBODIMENTS

The preferred embodiment of the present invention will now be described with the reference to accompanying drawings.

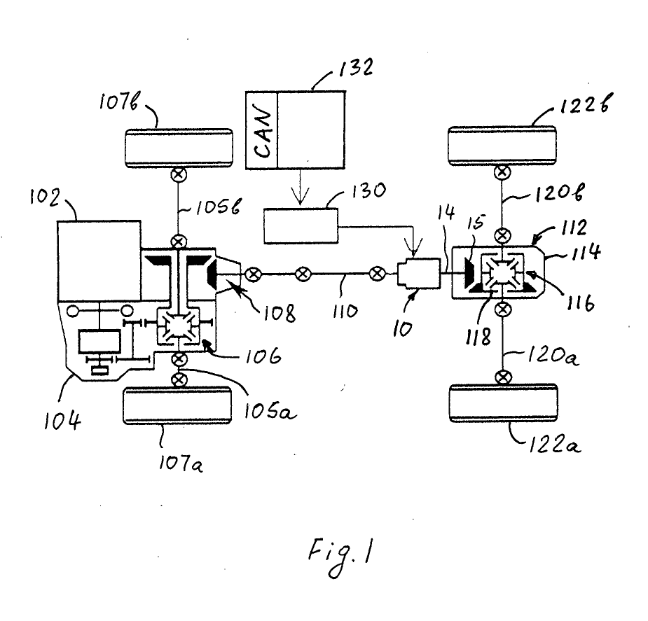

For purposes of the following description, certain terminology is used in the following description for convenience only and is not limiting. The words “right”, “left”, “rightward,” and “leftward” designate directions in the drawings to which reference is made. The words “outermost” and “innermost” refer to position in a vertical direction relative to a geometric center of the apparatus of the present invention and designated parts thereof. The terminology includes the words above specifically mentioned, derivatives thereof and words of similar import. Additionally, the word “a”, as used in the claims, means “at least one.” The present invention is directed to a hydraulically actuated torque coupling assembly including a hydraulic fluid pump, generally depicted by the reference numeral 10 in FIG. 1 that illustrates a preferred embodiment of the present invention. It will be appreciated that the hydraulically actuated torque coupling assembly of the present invention may be in any appropriate form, such as hydraulically actuated shaft coupling, auxiliary axle coupling for a motor vehicle, a power take-off coupling of a front-wheel-drive transaxle, etc.

FIG. 1 schematically depicts a drivetrain 100 of an all-wheel drive (AWD) motor vehicle in accordance with the preferred embodiment of the present invention. However, it is to be understood that while the present invention is described in relation to the all-wheel drive motor vehicle, the present invention is equally suitable for use in other hydraulically actuated friction couplings utilizing a speed sensitive hydraulic actuator.

The AWD drivetrain 100 comprises an internal combustion engine 102 mounted to a front end of the motor vehicle and coupled to a transaxle 104 of a front (primary) full-time axle, a power transfer unit 108, a propeller shaft 110 and a selectively, on-demand operable rear (auxiliary) axle assembly 112. However, it should be noted that the present invention could be used on a rear wheel drive primary driven axle vehicle or any other all-wheel drive or all wheel drive vehicle. The transaxle 104 includes a front differential unit 106 rotated by a drive torque from the engine 102, and two front axle shafts 105a and 105b outwardly extending from the front differential unit 106 and drivingly coupled to front wheels 107a and 107b, respectively. The auxiliary axle assembly 112 includes a rear differential unit 116 disposed in an axle housing 114, and two rear (auxiliary) axle shafts 120a and 120b outwardly extending from the rear differential unit 116 and drivingly coupled to rear wheels 122a and 122b, respectively.

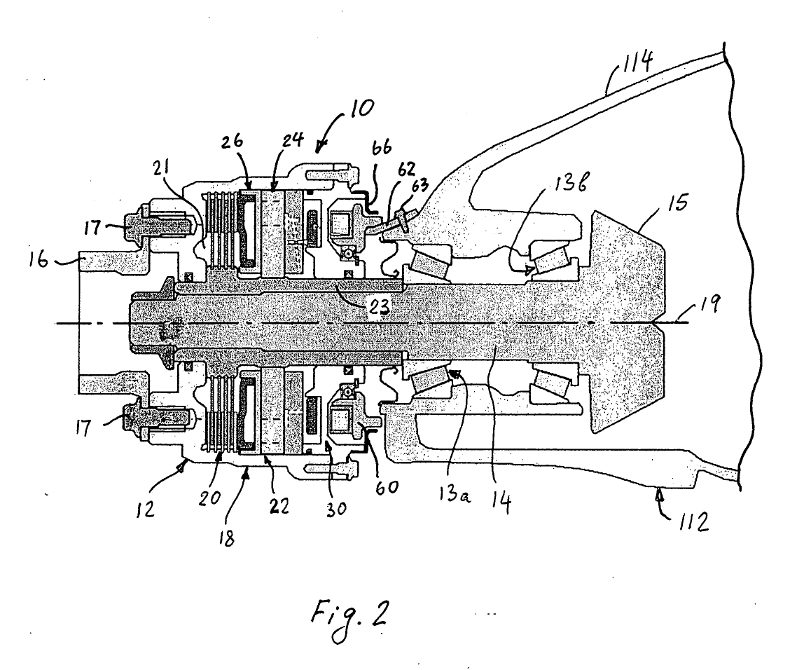

The drivetrain 100 further includes a selectively operable, hydraulically actuated torque-coupling device 10 adapted to selectively actuate the rear, auxiliary drive axle 112 of the AWD motor vehicle only when slippage of the wheels 107a and 107b occurs with the primary axle. FIG. 2 illustrates the torque-coupling device 10 operatively connected to the auxiliary axle assembly 112. It is to be understood that while the present invention is described in relation to the auxiliary drive axle of the AWD motor vehicle, the present invention is equally suitable for use in other hydraulically actuated friction couplings, such as torque coupling mechanisms for a gear-train utilizing a speed sensitive limited slip device.

The torque-coupling device 10 includes a hollow coupling case 12, an input member (or shaft) and an output member (or shaft). Preferably, the input member is in the form of a U-joint yoke 16 drivingly coupled to a distal end of the propeller shaft 110, while the output member is in the form of a pinion shaft member 14 of the auxiliary axle assembly 112. The pinion shaft member 14 is supported within the axle housing 114 for rotation about a central axis 19 through anti-friction bearings 13a and 13b. The propeller shaft 110 transmits a drive torque from the engine 102 to the input member 16 through the transaxle 104 and the power transfer unit 108. A pinion gear 15 of the pinion shaft member 14 drivingly engages a ring gear 118 of the differential unit 116. The hollow coupling case 12 is non-rotatably fastened to the input member 16, such as by bolts 17, for rotation about the central axis 19 relative to the axle housing 114 of the auxiliary axle assembly 112. In other words, both the input member 16 and the coupling case 12 are substantially coaxial to the pinion shaft member 14. Moreover, as the coupling case 12 is non-rotatably fastened to the input member 16, the coupling case 12 also constitutes the input member.

The torque-coupling device 10 further includes a limited slip device, preferably in the form of a hydraulically actuated friction clutch assembly 18. The friction clutch assembly 18 operatively and selectively connects the propeller shaft 110 and the rear differential unit 116. The clutch assembly 18 is selectively actuated by a corresponding hydraulic clutch actuator 22. Both the clutch assembly 18 and the clutch actuator 22 are disposed within the coupling case 12. The hydraulically actuated friction clutch assembly 18 is provided for selectively engaging and disengaging the input member 16 and the pinion shaft member 14, while the hydraulic clutch actuator 22 for selectively frictionally loading the friction clutch assembly 18. In other words, as the coupling case 12 is non-rotatably fastened to the input member 16, the friction clutch assembly 18 is provided for selectively drivingly connecting the coupling case 12 to the pinion shaft member 14.

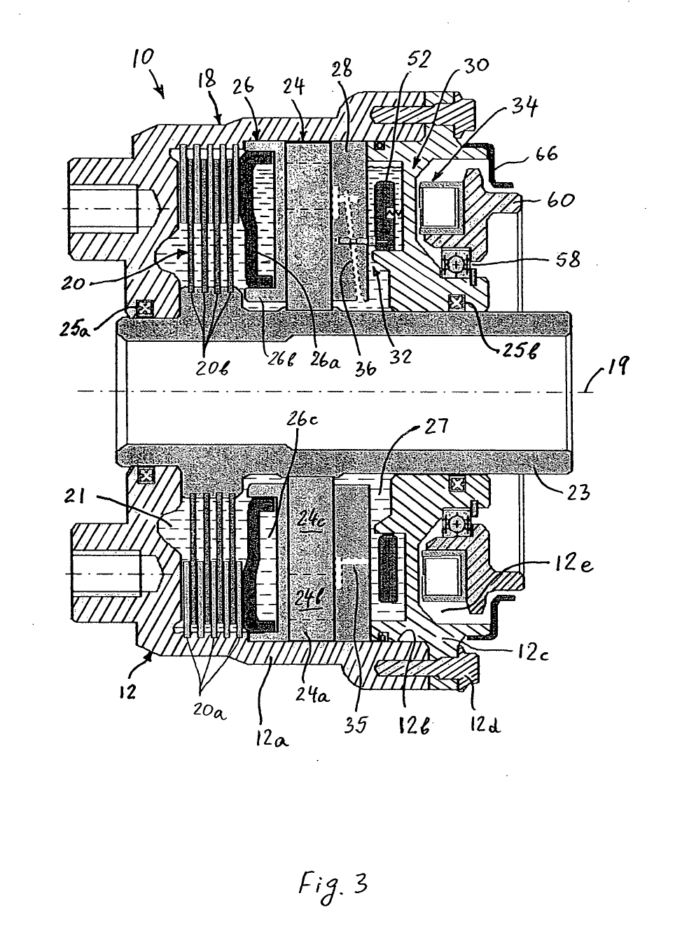

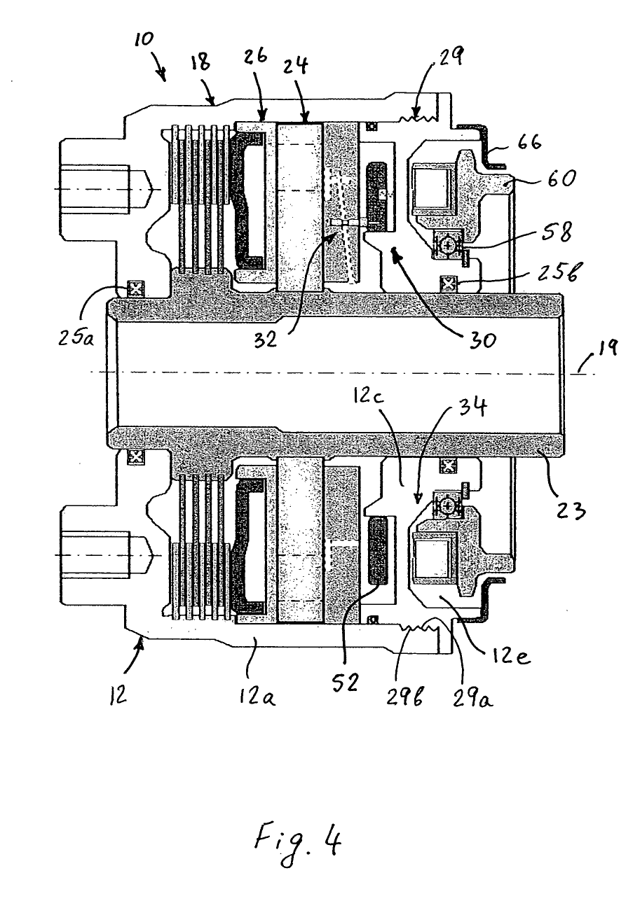

FIG. 3 illustrates in detail the torque-coupling device 10. Preferably, the coupling case 12 is made of aluminum and includes a hollow case member 12a defining an opening 12b therein, and a side cover member 12c fastened to the case member 12a by a plurality of threaded fasteners 12d, such as screws or bolts. Alternatively, the case member 12a is fastened to the cover member 12c by a threaded connection 29. More specifically, as shown in FIG. 4, threads 29a formed on an inner peripheral surface of the case member 12a adjacent to the opening 12b therein engage threads 29b formed on an outer peripheral surface of the cover member 12c.

The coupling case 12 is rotatably mounted about a substantially cylindrical drive sleeve 23, which, in turn, is non-rotatably mounted about the pinion shaft member 14 coaxially therewith by any appropriate means known in the art. The coupling case 12 is provided with annular elastic seal members 25a and 25b secured to the case member 12a and cover member 12c, respectively, in an axially spaced relationship. Both seal members 25a and 25b are in sealing and sliding contact with an outer peripheral surface of the drive sleeve 23. Thus, the elastic seal members 25a and 25b are provided for sealingly mounting the coupling case 12 about the drive sleeve 23 so as to form a substantially annular, fluidly sealed compartment 21 between the coupling case 12 and the drive sleeve 23. Moreover, the sealed compartment 21 contains a certain amount of a hydraulic fluid 27 therewithin for supplying hydraulic fluid to the hydraulic clutch actuator 22, thus defining a sealed hydraulic fluid reservoir.

In accordance with the preferred embodiment of the present invention, the hydraulic friction clutch assembly 18 is hydraulically actuated multi-plate clutch assembly including a friction clutch pack 20. The friction clutch pack 20, well known in the prior art, includes sets of alternating outer friction plates 20a and inner friction plates 20b. Conventionally, an outer circumference of the outer friction plates 20a is provided with projections that non-rotatably engage corresponding grooves formed in the coupling case 12. Similarly, an inner circumference of the inner friction plates 20b is provided with projections that non-rotatably engage corresponding grooves formed in the drive sleeve 23. At the same time, both the outer friction plates 20a and the inner friction plates 20b are slideable in the axial direction. The clutch plates 20a frictionally engage the clutch plates 20b to form a torque coupling arrangement between the coupling case 12 and the pinion shaft member 14.

The hydraulic clutch actuator 22 selectively actuates the clutch assembly 18. Preferably, the hydraulic clutch actuator 22 includes a speed sensitive positive displacement hydraulic pump 24 providing a pressurized hydraulic fluid, a piston assembly 26 for axially loading the clutch pack 20, and a variable pressure relief valve assembly 30 for selectively controlling a discharge pressure of the pump 24 and, subsequently, the clutch pack 20.

The variable pressure relief valve assembly 30 is operated by an electromagnetic (preferably, solenoid) actuator electronically controlled by a coupling control module (CCM) 130 (shown in FIG. 1) based on one or more vehicle parameters as control inputs 132, such as a vehicle speed, an accelerator pedal position, vehicle yaw rate, a vehicle lateral acceleration, a steering angle, an engine throttle valve position, a brake application, etc., through the CAN (Controller Area Network) bus. When energized, the variable pressure relief valve assembly 30 is capable of continuously modulating a discharge pressure of the pump 24 in a variable range from a minimum pressure to a maximum pressure, thereby selectively and variably controlling a drive torque applied to the pinion shaft member 14 in a range from a minimum torque value to a maximum torque value.

The speed sensitive hydraulic pump 24 disposed within the coupling case 12 actuates the clutch pack 20 when the relative rotation between the input member 16 and the pinion shaft member 14 occurs. It will be appreciated that a hydraulic pressure generated by the pump 24 is substantially proportional to a rotational speed difference between the coupling case 12 (thus, the input member 16) and the drive pinion shaft member 14. Preferably, the hydraulic pump 24 employed to provide pressurized hydraulic fluid to actuate the clutch pack 20 is a bidirectional (reversible) gerotor pump. The gerotor pump 24 includes an outer ring member 24a, an outer rotor 24b, and an inner rotor 24c. The inner rotor 24c is drivingly (non-rotatably) coupled (i.e., keyed or splined) to the drive sleeve 23 (thus to the pinion shaft member 14), and the outer ring member 24a is secured (i.e., keyed or splined) to the coupling case 12. The inner rotor 24c has a plurality of external teeth that rotate concentrically relative to the axis 19. The outer rotor 24b includes a plurality of internal teeth and has an outer circumferential edge surface that is rotatably supported within a circular internal bore formed in the outer ring member 24a. Preferably, the inner rotor 24c has one less tooth than the outer rotor 24b and when relative rotation between the inner rotor 24c and the outer ring member 24a occurs, it causes eccentric rotation of the outer rotor 24b, which can freely rotate within the outer ring member 24a eccentrically with respect to the inner rotor 24c, thus providing a series of decreasing and increasing volume fluid pockets by means of which fluid pressure is created. Therefore, when relative motion takes place between the drive pinion shaft member 14 and the input member 16, the gerotor pump 24 generates hydraulic fluid pressure. The outer ring member 24a has a 180° circumferential cut out (not shown) that engages a dowel pin (not shown) on the end plate 28. This engagement of the dowel pin and the outer ring member 24a allows the gerotor pump 24 to change over its pumping direction when the rotational direction of the coupling case 12 changes relative to the pinion shaft 14. However, it will be appreciated that any other appropriate type of hydraulic pump generating the hydraulic pressure in response to the relative rotation between the drive pinion shaft member 14 and the input member 16 is within the scope of the present invention.

The piston assembly 26 including a hydraulically actuated piston 26a disposed within a piston housing 26b, serves to compress the clutch pack 20 and retard any speed differential between the drive pinion shaft member 14 and the input member 16. The piston housing 26b is non-rotatably disposed on the coupling case 12 via the splines at the inner peripheral surface of the case member 12a of the coupling case 12. Pressurized hydraulic fluid to actuate the piston 26a and engage the clutch pack 20 is provided by the gerotor pump 24. In such an arrangement, when a speed difference between the drive pinion shaft member 14 and the input member 16 exists, the hydraulic fluid is drawn into the pump 24 from the sealed compartment (hydraulic fluid reservoir) 21. As illustrated in FIGS. 2 and 3, the hydraulic pump 24 is sandwiched between the piston housing 26b and an end plate 28 in the axial direction of the central axis 19. The end plate 28 is rotatably disposed on the drive sleeve 23, however it is non-rotatably mounted to an inner peripheral surface of the coupling case via a spline connection. The side cover member 12c of the coupling case 12 blocks the axial movement of the end plate 28 away from the gerotor pump 24. The gerotor pump 24 pumps the pressurized fluid into a piston pressure chamber 26c defined between the piston 26a and the piston housing 26b to actuate the clutch pack 20. As the speed difference increases, the pressure progressively increases. The pressurized fluid in the piston pressure chamber 26c creates an axial force upon the piston 26a for applying a compressive clutch engagement force on the clutch pack 20, thereby transferring drive torque from the input member 16 to the drive pinion shaft member 14 through the coupling case 12. The amount of torque transfer (i.e., the torque ratio or split) is progressive and continuously variable and is proportional to the magnitude of the clutch engagement force exerted by the piston 26a on the clutch pack 20 which, in turn, is a function of the fluid pressure within the piston chamber 26c. Moreover, the magnitude of the fluid pressure within piston pressure chamber 26c, as delivered thereto by the hydraulic pump 24, is largely a function of the speed differential between the input member 16 and the drive pinion shaft member 14.

When the friction clutch assembly 18 is actuated by the hydraulic clutch actuator assembly, the outer clutch plates 20a frictionally engage the inner clutch plates 20b to form a torque coupling between the coupling case 12 and the pinion shaft member 14. As described above, the hydraulic pump 24 actuates the friction clutch assembly 18 depending on the relative rotation between the coupling case 12 and the drive sleeve 23, i.e. the pinion shaft member 14. More specifically, the speed sensitive fluid pump 24 actuates the piston assembly 26 that compresses (axially loading) the friction clutch assembly 18 to increase the frictional engagement between the clutch plates 20a and 20b.

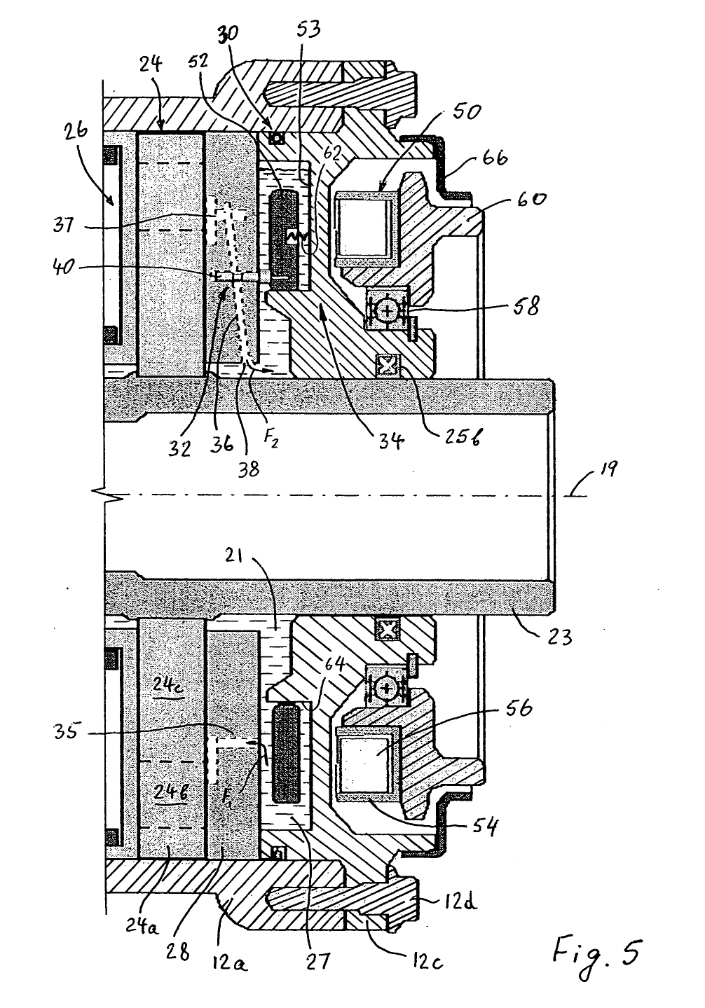

As noted above, in order to control the fluid pressure generated by the hydraulic pump 24 (thus the fluid pressure within the piston pressure chamber 26c and, subsequently, the output torque distribution of the torque-coupling device 10), the hydraulic clutch actuator 22 is provided with the variable pressure relief valve assembly 30. As illustrated in detail in FIG. 5, the variable pressure relief valve assembly 30 according to the present invention is in the form of an electromagnetic valve assembly comprising a valve closure member in the form of a pressure control spool valve 32 disposed within the coupling case 12 and controlled by an electromagnetic actuator 34 that may be any appropriate electromagnetic device well known in the art, such as a solenoid. As further shown in FIGS. 3 and 4, the end plate 28 is provided with at least one, preferably more than one, inlet port (or suction passage) 35 formed therewithin through which the hydraulic fluid is drawn into the hydraulic pump 24 from the sealed compartment (hydraulic fluid reservoir) 21 (depicted by the reference mark F₁ in FIG. 5), and at least one fluid control passage 36 through which the hydraulic fluid exits the hydraulic pump 24 and into the sealed compartment 21 (depicted by the reference mark F₂ in FIG. 5). Preferably, the inlet port 35 and the fluid control passage 36 are formed within the end plate 28 disposed in the coupling case 12 adjacent to the hydraulic pump 24. The fluid control passage 36 is in fluid communication with an outlet port of the hydraulic pump 24 through an inlet opening 37 formed in the end plate 28. The hydraulic fluid leaves the fluid control passage 36 through an exit opening 38 provided at a radially innermost end of the fluid control passage 36. In other words, the hydraulic fluid released from the hydraulic pump 24 enters the fluid control passage 36 through the inlet opening 37 and leaves the fluid control passage 36 through the exit opening 38, as illustrated in FIG. 5 by the reference mark F₂. Preferably, the inlet port 35 and the control passage 36 are formed within the end plate 28 by drilling. Alternatively, the inlet port 35 and the control passage 36 could be formed by casting, or any other appropriate method known in the art.

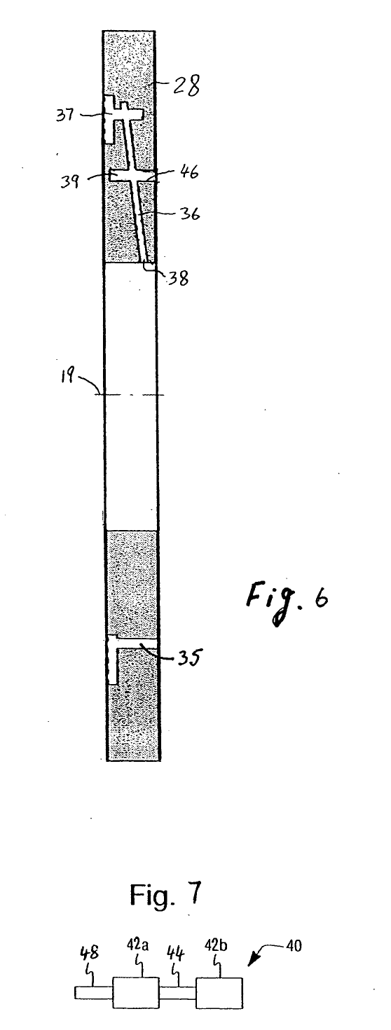

The pressure-control valve 32 according to the present invention is a spool valve that comprises a spool member 40 disposed in a valve chamber (or valve bore) 39 for sliding movement therewithin. The valve bore 39 is formed in the end plate 28 across the fluid control passage 36. In other words, the valve bore 39 is in fluid communication with the fluid control passage 36. Preferably, as illustrated in detail in FIG. 6, the valve bore 39 is substantially cylindrical in cross-section and is formed as a dead-ended drill hole in the end plate 28 from an axially outer face thereof facing the cover member 12c of the coupling case 12. The fluid control passage 36 is drilled across a central portion of the valve bore 39. The 20 inlet opening 37 is drilled in the end plate 28 from an inner face thereof facing the pump 24 as another dead-ended hole through the fluid control passage 36, thus fluidly connecting the fluid control passage 36 with the outlet port of the hydraulic pump 24.

The spool member 40, illustrated in detail in FIG. 7, includes two substantially cylindrical land portions 42a and 42b axially spaced by a central portion (or valve stem) 44 of a reduced size relative to the land portions 42a and 42b. The land portions 42a and 42b of the spool member 40 slidingly engage a complementary inner peripheral surface 46 of the valve bore 39 (shown in FIG. 6). The spool member 40 further includes a connecting portion (or shaft) 48 axially extending therefrom. The connecting portion 48 is provided for mounting the spool member 40 to the electromagnetic actuator 34.

The spool member 40 of the pressure-control valve 32 is axially movable within the valve bore 39 by the electromagnetic actuator 34 between a closed position when the land portion 42b of the spool member 40 blocks the fluid control passage 36 (not shown), and an open position thereof when the reduced diameter central portion 44 of the spool member 40 is axially registered with the fluid control passage 36 so as to allow hydraulic fluid in the fluid control passage 36 freely flow through the spool valve 32 across the spool member 40 (as shown in FIGS. 3 and 4). Also, the spool valve 32 may be positioned in a partially closed position (i.e. between open and closed positions) so that the spool member 40 partially blocks the fluid control passage 36.

As best shown in FIGS. 3 and 4, the electromagnetic actuator 34 is mounted to the cover member 12c of the coupling case 12. The electromagnetic actuator 34 comprises an annular electromagnetic coil (or solenoid) assembly 50 and an armature 52 axially movable in the direction of the central axis 19. Preferably, the armature 52 is in the form of an annular armature disc and both the coil assembly 50 and the armature disc 52 are disposed substantially coaxially with the central axis 19.

The electro-magnetic coil assembly 50 comprises a substantially annular coil housing 54 and a coil winding 56 wound about the coil housing 54. The coil housing 54 is formed of a single or a plurality of laminations of a magnetically permeable material, such as conventional ferromagnetic materials. The electro-magnetic coil assembly 50 is non-rotatably mounted to a magnet holder 60 outside the coupling case 12 within an annular groove 51 formed in the cover member 12c of the coupling case 12. In turn, the magnet holder 60 is supported by the cover member 12c of the coupling case 12 substantially coaxially to the axis 19 through an anti-friction bearing 58 (such as ball bearing) for rotation relative to the coupling case 12. The magnet holder 60 is made of any appropriate non-magnetic material well known to those skilled in the art, such as plastic. Preferably, both the coil assembly 50 and the magnet holder 60 are at least partially disposed in a recess 12e formed in the cover member 12c of the coupling case 12, as illustrated in FIGS. 2 and 3. The magnet holder 60 has at least one tab 62 fixed thereto. The tab 62 is fastened to the axle housing 114 with a corresponding threaded fastener 63, as shown in FIG. 2, in order to non-rotatably secure the magnet holder 60 to the axle housing 114. Consequently, the coil assembly 50 is non-rotatable relative to the axle housing 114, while the coupling case 12 is rotatable relative to the axle housing 114 and the coil assembly 50. A dust cover 66 is attached to the cover member 12c for protecting the coil assembly 50 against dust and foreign material, such as road debris. Alternatively, the dust cover 66 may be attached to the magnet holder 60.

The armature disc 52 is disposed inside the coupling case 12 axially inwardly of the electromagnetic coil assembly 50 and substantially coaxially thereto. Moreover, the armature disc 52 is coaxial to the coil winding 56 and is axially spaced from an inner surface 53 of the cover member 12c of the coupling case 12, thus defining an air gap 57. The spool member 40 of the spool valve 32 is securely attached to the armature disc 52 by any appropriate manner known in the art. Preferably, the connecting portion 48 axially extending from the spool member 40 is press-fit at an axially inner face of the armature 52 (as illustrated in FIG. 5). A preloaded spring 62, such as coil spring or wave spring, is operatively disposed between the inner surface 53 of the cover member. 12c and an axially outer face of the armature disc 52 for urging (biasing) the spool member 40 leftward (as shown in FIG. 5) toward the end plate 28 to the open position of the spool valve 32. In other words, the pressure-control spool valve 32 defines a normally-open valve.

As further shown in FIGS. 3 and 4, the annular armature disc 52 is mounted about a support flange 64 formed integrally with the cover member 12c of the coupling case 12 so as to extend into the sealed compartment 21 thereof. Moreover, an annular outer peripheral surface of the support flange 64 is substantially coaxial with the central axis 19. The support flange 64 supports the armature disc 52 within the coupling case 12 and guides the axial movement thereof in the direction of the central axis 19. Preferably, the armature disc 52 is non-rotatably mounted to the support flange 64 of the cover member 12c of the coupling case 12, forcing the armature disc 52 to rotate together with the coupling case 12.

In operation, when the rotational speed difference between the pinion shaft member 14 and the propeller shaft 110 occurs, the hydraulic pump 24 is activated to draw the hydraulic fluid from the sealed compartment (hydraulic fluid reservoir) 21 through the inlet port 35 into the hydraulic pump 24.

When no electrical current or a minimum current is supplied to the coil winding 56 of the electromagnetic coil assembly 50, the electromagnetic force applied to the armature disc 52 is at its minimum, and the spring 62 urges the spool member 40 leftward (as shown in FIGS. 3 and 4) setting the spool valve 32 in the open position. Consequently, the hydraulic fluid flow generated by the pump 24 freely exits the outlet port of the pump 24 via the fluid control passage 36 in the end plate 28 through the open spool valve 32. In this configuration, the pump 24 does not generate sufficient fluid pressure so that the hydraulic pressure which can be obtained in the piston pressure chamber 26c of the piston assembly 26 is not high enough to engage the clutch pack 20, essentially disengaging the clutch assembly 18 and disconnecting the pinion shaft member 14 of the auxiliary axle assembly 112 from the propeller shaft 110. In other words, if no electrical current or a minimum current is supplied to the coil winding 56 of the electromagnetic coil assembly 50, a minimum fluid pressure is provided by the spool valve 32 within the piston pressure chamber 26c, and the torque-coupling device 10 is effectively disabled, i.e. is in a fully “OFF” condition.

As best shown in FIGS. 2-4, when electrical current is supplied to the coil winding 56, a magnetic flux is caused to flow through the armature disc 52. The magnetic flux creates an electromagnetic force that axially displaces the armature disc 52 toward the electromagnetic coil assembly 50. The armature disc 52 selectively displaces the spool member 40 rightward, away from the pump 24 against the compressing force of the spring 62 with a predetermined axial magnetic force that is a function of the electrical current supplied to the coil winding 56. Thus, the displacement of the armature disc 52 is determined by the balancing of the electromagnetic force generated by the electromagnetic coil assembly 50 and the compressing force of the spring 62. It will be appreciated by those skilled in the art that the spool member 40 will move until the axial magnetic force is larger than the axial compressing force of the spring 62 exerted to the armature disc 52 by the magnetic flux generated by the coil winding 56, thereby pulling the spool member 40 rightward, away from the pump 24 and out of the open position and toward its closed position. In such a position, the spool member 40 mounted to the armature disc 52, at least partially closes the fluid control passage 36 in proportion to its displacement, choking the hydraulic fluid flow through the fluid control passage 36, thus increasing the fluid pressure generated by the hydraulic pump 24. In this manner, by adjusting the electric current supplied to the electromagnetic actuator 34, the fluid pressure to the piston assembly 26 can be controlled.

Therefore, such an arrangement creates the pressure-control valve assembly 30 which regulates a magnitude of hydraulic pressure in the piston pressure chamber 26c that is a function of the current supplied to the coil winding 56. Thus, the variable pressure-control valve assembly 30 selectively sets the hydraulic pressure generated by the hydraulic pump 24 based on the magnitude of the electrical current supplied to the electromagnetic actuator 34 and, subsequently, defines the magnitude of the pressure within the piston pressure chamber 26c. The fluid pressure limit of the pressure-control valve 32, i.e. the fluid pressure generated by the pump 24, can be adjusted by controlling the current applied to the co coil winding 56 of the electromagnetic actuator 34. As less current is applied to the coil winding 56, less axial electromagnetic force is exerted to the spool valve 32, thus the less is the fluid pressure generated by the hydraulic pump 24. This results in an adjustment mechanism for regulating the fluid pressure attainable within the piston pressure chamber 26c of the friction clutch assembly 18.

When a maximum current is applied to the coil winding 56 of the solenoid actuator 34, the electromagnetic force generated by the electromagnetic actuator 34 and thus the pulling force acting to the pressure-control spool valve 32 is at its maximum. This electromagnetic force displaces the spool member 40 away from the end plate 28 to its closed position when the land portion 42b of the spool member 40 completely blocks the fluid control passage 36. In such a position, the hydraulic pressure attainable in the piston pressure chamber 26c of friction clutch assembly 18 is at its maximum and sufficient to fully actuate the friction clutch pack 20 which results in fully engaging the torque-coupling device 10. In other words, if the maximum current is supplied to the coil winding 56 of the electro-magnetic coil assembly 50, the torque-coupling device 10 is fully engaged, i.e. is in a fully “ON” condition.

In between the “ON” and “OFF” conditions of the torque-coupling device 10, the fluid pressure generated by the pump 24, i.e. the fluid pressure attainable in the piston pressure chamber 26c, may be set at any value by modulating the current applied to the coil winding 56 of the solenoid actuator 34. This provides the torque-coupling device 10 with an infinitely variable fluid pressure in which the amount of the slip available to the clutch assembly 18 can be optimized to match various vehicle operating conditions. This provides an opportunity to dynamically control the hydraulic pressure for traction enhancement. For example, if the pressure generated by the pump 24 is set at a low value, a control system can be used to sense wheel speeds or speed differences and allow for increased hydraulic pressure. The increase in pressure available may be a function of the speed difference. This will result in an optimized amount of limited slip between the fully “ON” and “OFF” conditions.

During normal operation, the torque-coupling device 10 is in the “OFF” position as the minimum current is applied to the variable pressure relief valve assembly 30, thus disabling the friction clutch assembly 18. However, if the wheels 107a and 107b of the primary axle lose traction, the CCM 130 issues a signal to the variable pressure relief valve assembly 30 to set the torque-coupling device 10 in the “ON” position. This will set the maximum pressure generated by the pump 24 and provided by the pressure-control valve 32. The differential speed between the input member 16 and the pinion shaft member 14 will result in the hydraulic pump 24 delivering pressurized fluid at its maximum value to the piston chamber 26c, and the friction clutch pack 20 will be fully engaged. With the clutch pack 20 engaged, the wheels 122a and 122b of the auxiliary axle assembly 112 of the vehicle will be driven. Therefore, in accordance with the present invention, the AWD system is actuated only when the vehicle input sensors sense a reduction in traction at the front wheels 107a and 107b. Also, the AWD system may by actuated manually by a vehicle operator.

Moreover, when energized, the variable pressure relief valve assembly 30 is capable of modulating a pump discharge pressure in a variable range from a minimum pressure to a maximum pressure, thereby selectively and variably controlling a drive torque applied to the wheels of the auxiliary axle in a range from a minimum torque value to a maximum torque value. Thus, the torque-coupling assembly in accordance with the present invention allows infinitely variable torque distribution between the primary axle and the auxiliary axle. Furthermore, the torque-coupling assembly is self-contained so that it does not require a supply of hydraulic fluid stored outside the frictional clutch assembly.

The description of the preferred embodiment of the present invention has been presented for the purpose of illustration in accordance with the provisions of the Patent Statutes. It is not intended to be exhaustive or to limit the invention to the precise forms disclosed. For example, it is to be understood that while the present invention is described in relation to a hydraulically actuated torque-coupling assembly, the present invention is equally suitable for use in other hydraulically actuated torque couplings, such as torque coupling mechanisms for speed sensitive limited slip differential units. Additionally, although FIG. I shows a rear-wheel drive embodiment of the invention, the invention is equally applicable to a front-wheel drive configuration of the vehicular drivetrain.

The foregoing description of the preferred embodiment of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A torque-coupling assembly comprising:
a shaft member;
a fluidly sealed hollow coupling case containing an amount of a fluid therewithin, said sealed coupling case rotatably mounted about said shaft member;
a friction clutch assembly disposed within said coupling case for selectively drivingly connecting said coupling case and said shaft member; and
a fluid pump disposed within said coupling case for generating a fluid pressure to frictionally load said clutch assembly and supplied with said fluid contained in said coupling case.

2. The torque-coupling assembly as defined in claim 1, further comprising:
a fluid control passage through which said fluid discharged from said fluid pump into said coupling case; and
a variable pressure-control valve assembly including a valve closure member disposed within said coupling case and an electro-magnetic actuator for producing a variable axial electromagnetic force acting against said valve closure member so as to selectively control the flow rate of said fluid through said fluid control passage.

3. The torque-coupling assembly as defined in claim 2, wherein said valve closure member is in the form of a spool valve disposed in said fluid control passage, and wherein said electromagnetic actuator produces said variable axial electromagnetic force acting against said spool valve so as to selectively adjust the position of said spool valve in said fluid control passage in order to selectively control the flow rate of said fluid in said fluid control passage.

4. The torque-coupling assembly as defined in claim 3, wherein said electro-magnetic actuator includes an electromagnetic coil assembly disposed outside said coupling case and an armature disposed inside said coupling case and axially movable relative to said electro-magnetic coil assembly.

5. The torque-coupling assembly as defined in claim 4, wherein said electromagnetic coil assembly is disposed outside said coupling case and said armature is disposed inside said coupling case.

6. The torque-coupling assembly as defined in claim 4, wherein the position of said spool valve is selectively adjustable between an open position allowing flow of said fluid through said fluid control passage and a closed position blocking flow of said fluid through said fluid control passage.

7. The torque-coupling assembly as defined in claim 6, wherein said spool valve includes a spool member disposed in a valve chamber for sliding movement therewithin; said valve chamber is in fluid communication with said fluid control passage; said spool valve is mounted to said armature.

8. The torque-coupling assembly as defined in claim 7, wherein said fluid control passage is formed through an end plate adjacent to said fluid pump and said valve chamber is formed in said end plate across said fluid control passage.

9. The torque-coupling assembly as defined in claim 4, wherein said electromagnetic coil assembly is rotatably mounted to said coupling case.

10. The differential assembly as defined in claim 3, further including a piston assembly disposed within said coupling case between said pump and said clutch assembly and defining a pressure chamber, wherein said variable pressure-control valve assembly selectively controls a fluid pressure attainable within said pressure chamber.

11. The torque-coupling assembly as defined in claim 10, wherein said variable pressure-control valve assembly selectively controls said pressure attainable within said pressure chamber between a maximum pressure when said spool valve is in said closed position and a minimum pressure when said spool valve is in said open position so as to enable partial actuation of said friction clutch assembly.

12. The torque-coupling assembly as defined in claim 11, wherein said minimum pressure attainable within said pressure chamber is at a level that prevents actuation of said friction clutch assembly, and wherein said maximum pressure attainable within said pressure chamber is at a level that enables complete actuation of said friction clutch assembly.

13. The torque-coupling assembly as defined in claim 2, wherein said selective control of said friction clutch assembly is determined in response to at least one vehicle parameter.

14. The torque-coupling assembly as defined in claim 1, wherein said torque-coupling assembly is provided for selectively actuating of a auxiliary drive axle assembly of an all-wheel-drive motor vehicle; and wherein said coupling case is drivingly coupled to a propeller shaft of said motor vehicle.

15. The torque-coupling assembly as defined in claim 20, wherein said auxiliary drive axle assembly includes a differential unit, and wherein said shaft member is a drive pinion shaft of said auxiliary drive axle assembly drivingly coupled with a ring gear of said differential unit.

16. A torque-coupling assembly in a drivetrain of an all-wheel-drive motor vehicle for selectively actuating of an auxiliary drive axle assembly of said motor vehicle, said auxiliary drive axle assembly including a differential unit, said torque-coupling assembly comprising:
a pinion shaft drivingly coupled with a ring gear of said differential unit;
a fluidly sealed hollow coupling case containing an amount of a fluid therewithin, said sealed coupling case rotatably mounted about said pinion shaft;
a friction clutch assembly disposed within said coupling case for selectively drivingly connecting said coupling case and said shaft member; and
a fluid pump disposed within said coupling case for generating a fluid pressure to frictionally load said clutch assembly and supplied with said fluid contained in said coupling case.

17. The torque-coupling assembly as defined in claim 16, further comprising:
a fluid control passage through which the fluid discharged from said fluid pump into said coupling case; and
a variable pressure-control valve assembly including a valve closure member disposed within said coupling case and an electromagnetic actuator for producing a variable axial electro-magnetic force acting against said valve closure member so as to selectively control the flow rate of said fluid through said fluid control passage.

18. The torque-coupling assembly as defined in claim 17, wherein said valve closure member is in the form of a spool valve disposed in said fluid control passage, and wherein said electro-magnetic actuator produces said variable axial electromagnetic force acting against said spool valve so as to selectively adjust the position of said spool valve in said fluid control passage in order to selectively control the flow rate of said fluid in said fluid control passage.

19. The torque-coupling assembly as defined in claim 18, wherein said electro-magnetic actuator includes an electro-magnetic coil assembly disposed outside said coupling case and an armature disposed inside said coupling case and axially movable relative to said electromagnetic coil assembly.

20. The torque-coupling assembly as defined in claim 19, wherein said electro-magnetic coil assembly is disposed outside said coupling case and is non-rotatably mounted to an axle housing of said auxiliary drive axle assembly; said armature is disposed inside said coupling case.

21. The torque-coupling assembly as defined in claim 20, wherein the position of said spool valve is selectively adjustable between an open position allowing flow of said fluid through said fluid control passage and a closed position blocking flow of said fluid through said fluid control passage.

22. The torque-coupling assembly as defined in claim 21, wherein said fluid control passage is formed through an end plate adjacent to said fluid pump and said valve chamber is formed in said end plate across said fluid control passage.

23. A torque-coupling assembly comprising:
a case containing fluid;
a shaft rotatably mounted within said case;
a friction clutch assembly disposed within said case for selectively drivingly connecting said case to said shaft; and
a pump within said case for loading said clutch assembly, said pump being supplied with fluid contained in said case.
